(19) United States
(12) Patent Application Publication
(10) Pub. No.: US 2013/0064436 A1
(43) Pub. Date: Mar. 14, 2013

(54) MEDICAL IMAGE PROCESSING APPARATUS AND METHOD OF OPERATING MEDICAL IMAGE PROCESSING APPARATUS

(71) Applicant: OLYMPUS MEDICAL SYSTEMS CORP., Tokyo (JP)

(72) Inventors: Kenichi TANAKA, Tokyo (JP); Hirokazu NISHIMURA, Tokyo (JP); Sawako SHIBATA, Tokyo (JP); Miho SAWA, Tokyo (JP)

(73) Assignee: OLYMPUS MEDICAL SYSTEMS CORP., Tokyo (JP)

(21) Appl. No.: 13/672,747

(22) Filed: Nov. 9, 2012

Related U.S. Application Data
(63) Continuation of application No. PCT/JP2012/056519, filed on Mar. 14, 2012.

(30) Foreign Application Priority Data
May 10, 2011 (JP) 2011-105596

(51) Int. Cl. G06T 7/00

(52) U.S. Cl. CPC G06T 7/0012
USPC 382/128

(57) ABSTRACT

A medical image processing apparatus includes: a feature value calculation portion that, for each pixel of an image, calculates a feature value that is used when extracting a linear structure; a judgment portion that, based on a result of a comparison between the feature value of a pixel of interest and feature values of a plurality of pixels located in the vicinity of the pixel of interest, judges whether the pixel of interest is a linear structure pixel or is a nonlinear structure candidate pixel; and a correction portion that identifies a pixel that is determined to be a linear structure pixel that is in the vicinity of the nonlinear structure candidate pixel, calculates information with respect to the identified linear structure candidate pixel and determines whether to make the nonlinear structure candidate pixel the nonlinear structure pixel or the linear structure pixel based on the calculated information.

### CROSS REFERENCE TO RELATED APPLICATION

This application is a continuation application of PCT/JP2012/056519 filed on Mar. 14, 2012 and claims benefit of Japanese Application No. 2011-105596 filed in Japan on May 10, 2011, the entire contents of which are incorporated herein by this reference.

### BACKGROUND OF THE INVENTION

1. Field of the Invention

The present invention relates to a medical image processing apparatus and a method of operating the medical image processing apparatus, and more particularly to a medical image processing apparatus that performs processing with respect to an image obtained by picking up an image of living tissue inside a body cavity and a method of operating the medical image processing apparatus.

2. Description of the Related Art

Endoscope systems that include an endoscope and a medical image processing apparatus and the like are in widespread use. More specifically, for example, an endoscope system includes: an endoscope having an insertion portion that is inserted into a body cavity of a subject, an objective optical system disposed at a distal end portion of the insertion portion, and an image pickup portion that picks up an image of an object inside the body cavity that is formed by the objective optical system and outputs the picked-up image as an image pickup signal; and a medical image processing apparatus that performs processing for displaying an image of the object on a monitor or the like as a display portion based on the image pickup signal. By using an endoscope system having the aforementioned configuration, the operator can observe various findings such as a color tone of a mucosa in a digestive tract mucosa such as the stomach, the shape of a lesion, and a fine structure of the mucosal surface.

Research regarding technology referred to as CAD (“Computer Aided Diagnosis” or “Computer Aided Detection”) that, based on image data obtained by picking up an image of an object with an endoscope or the like, can aid discovery and diagnosis of lesions by extracting a region in which structures such as microvessels or pits (glandular openings) are present on mucosal epithelium in a body cavity and presenting the results of extracting the region has been proceeding in recent years. Such research is described, for example, in Kenshi Yao et al., “Sokiigan no bisyokekkankochikuzo niyoru sonzai oyobi kyokaishindan (Diagnosis of Presence and Demarcations of Early Gastric Cancers Using Microvascular Patterns),” Endoscopia Digestiva, Vol. 17, No. 12, pp. 2093-2100, 2005.

Further, for example, in Toshiaki Nakagawa et al., “Recognition of Optic Nerve Head Using Blood-Vessel-Erased Image and Its Application to Simulated Stereogram in Computer-Aided Diagnosis System for Retinal Images,” IEICE Trans. D, Vol. J89-D, No. 11, pp. 2491-2501, 2006, technology is described that, based on image data obtained by picking up an image of an object with an endoscope or the like, obtains a detection result of a blood vessel region as a region in which it can be regarded that a blood vessel actually exists by extracting blood vessel candidate regions as regions in which it is possible for blood vessels to exist and performing a correction process such as expansion or reduction of a region with respect to the extraction results of the blood vessel candidate regions.

In this connection, among the respective wavelength bands that constitute RGB light, hemoglobin inside erythrocytes has a strong absorption characteristic in the G (green) light band. Therefore, for example, in image data obtained when RGB light is irradiated at an object that includes a blood vessel, there is a tendency for a concentration value of G (green) of a region in which a blood vessel exists to be relatively low in comparison to a concentration value of G (green) of a region in which a blood vessel does not exist. As technology that takes this tendency into consideration, for example, technology that performs extraction of blood vessel candidate regions by applying a band-pass filter to image data obtained by picking up an image of an object with an endoscope or the like is known.

### SUMMARY OF THE INVENTION

A medical image processing apparatus according to one aspect of the present invention includes: a feature value calculation portion that, for each pixel of an image that is obtained by picking up an image of living tissue, calculates a feature value that is used when extracting a linear structure from the image; a judgment portion that, based on a result of a comparison between the feature value that is calculated for a first pixel of interest in the image and the feature values that are calculated for a plurality of pixels located in a vicinity of the first pixel of interest, judges whether the first pixel of interest is a linear structure pixel that corresponds to a linear structure or is a nonlinear structure candidate pixel; and a correction portion that, by extraction, identifies a pixel that is determined to be a linear structure pixel that is in a vicinity of the nonlinear structure candidate pixel, calculates information with respect to the identified linear structure candidate pixels that is necessary for identifying whether to make the nonlinear structure candidate pixel the linear structure pixel or a nonlinear structure pixel, and determines whether to make the nonlinear structure candidate pixel the nonlinear structure pixel or the linear structure pixel based on the information that is calculated.

A method of operating a medical image processing apparatus according to one aspect of the present invention includes: a feature value calculation step of, for each pixel of an image that is obtained by picking up an image of living tissue, calculating a feature value that is used when extracting a linear structure from the image; a judgment step of, based on a result of a comparison between the feature value that is calculated for a first pixel of interest in the image and the feature values that are calculated for a plurality of pixels located in a vicinity of the first pixel of interest, judging whether the first pixel of interest is a linear structure pixel that corresponds to a linear structure or is a nonlinear structure candidate pixel; and a correction step of, by extraction, identifying a pixel that is determined to be a linear structure pixel that is in a vicinity of the nonlinear structure candidate pixel, calculating information with respect to the identified linear structure candidate pixels that is necessary for identifying whether to make the nonlinear structure candidate pixel the linear structure pixel or a nonlinear structure pixel, and determining whether to make the nonlinear structure candidate pixel the nonlinear structure pixel or the linear structure pixel based on the information that is calculated.

### BRIEF DESCRIPTION OF THE DRAWINGS

FIG. 1 is a diagram that shows the configuration of principal parts of a medical system that includes a medical image processing apparatus according to an embodiment of the present invention.

FIG. 2 is a diagram that shows an example of the configuration of a calculation processing portion that the medical image processing apparatus includes.

FIG. 3 is a flowchart that shows an example of processing performed by the medical image processing apparatus.

FIG. 4 is a diagram for describing a positional relationship between a pixel of interest P and peripheral pixels P1 to P8.

FIG. 5 is a diagram that shows an example of a result of extracting blood vessel candidate regions.

FIG. 6 is a diagram that shows an example of a result of extracting reference structures of blood vessel candidate regions.

FIG. 7 is a flowchart that shows an example of processing relating to correction of a reference structure of a blood vessel candidate region.

FIG. 8 is a diagram that shows an example of blood vessel candidate regions after correction.

FIG. 9 is a flowchart that shows an example of processing for correcting the blood vessel candidate region.

FIG. 10 is a diagram for explaining a positional relationship between a pixel of interest PM and other pixels.

FIG. 11 is a flowchart that shows an example of processing for correcting the blood vessel candidate region that is different to the example shown in FIG. 9.

FIG. 12 is a flowchart that shows an example of processing for correcting the blood vessel candidate region that is different to the examples shown in FIG. 9 and FIG. 11.

FIG. 13 is a flowchart that shows an example of processing for correcting the blood vessel candidate region that is different to the examples shown in FIG. 9, FIG. 11 and FIG. 12.

FIG. 14 is an explanatory diagram for explaining a closed region CR.

FIG. 15 is a flowchart that shows an example of processing for correcting the blood vessel candidate region that is different to the examples shown in FIG. 9, FIG. 11, FIG. 12 and FIG. 13.

### DETAILED DESCRIPTION OF THE PREFERRED EMBODIMENTS

Hereunder, embodiments of the present invention are described with reference to the drawings.

### First Embodiment

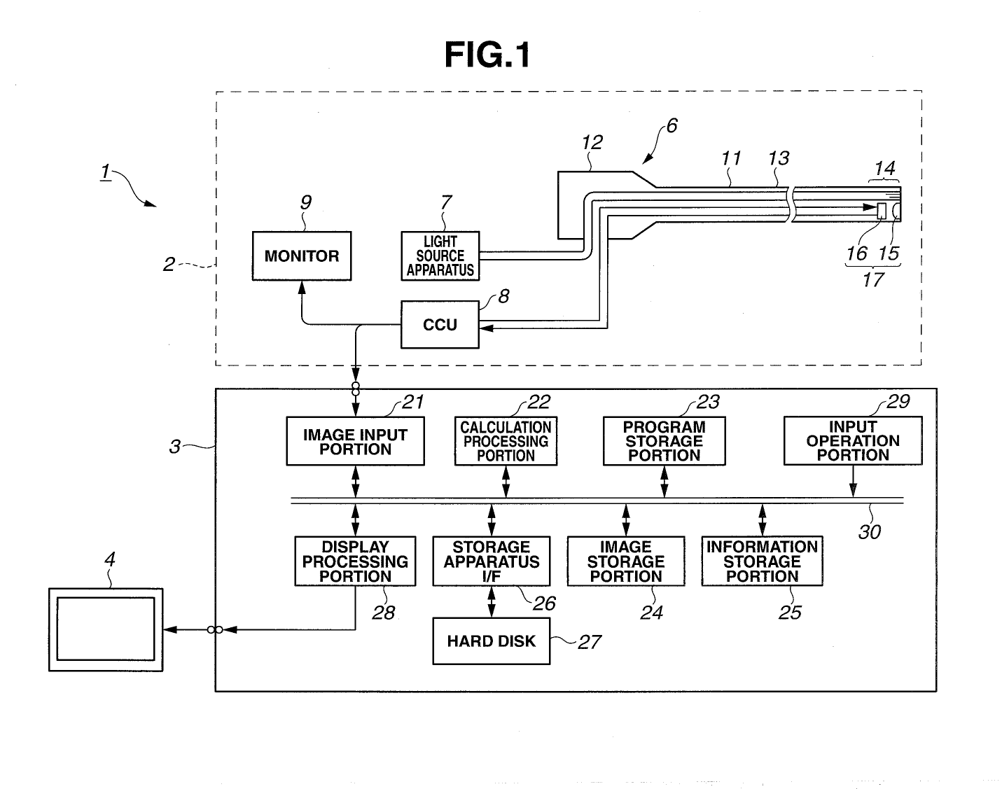

FIG. 1 to FIG. 11 relate to a first embodiment of the present invention.

FIG. 1 is a diagram that shows the configuration of principal parts of a medical system that includes a medical image processing apparatus according to an embodiment of the present invention.

As shown in FIG. 1, a medical system 1 includes: a medical observation apparatus 2 that picks up an image of living tissue as an object inside a body cavity and outputs a video signal; a medical image processing apparatus 3 that is constituted by a personal computer or the like and performs image processing with respect to the video signal that is outputted from the medical observation apparatus 2, and that outputs the processed video signal as an image signal; and a monitor 4 that displays an image based on the image signal that is outputted from the medical image processing apparatus 3.

The medical observation apparatus 2 includes: an endoscope 6 that is inserted into a body cavity and picks up an image of an object inside the body cavity, and outputs the image as an image pickup signal; a light source apparatus 7 that supplies illuminating light (for example, RGB light) for illuminating the object picked up by the endoscope 6; a camera control unit (hereinafter, abbreviated as “CCU”) 8 that performs various kinds of control with respect to the endoscope 6, executes signal processing on the image pickup signal that is outputted from the endoscope 6 to thereby generate a video signal, and outputs the generated video signal; and a monitor 9 that displays an image of the object picked up by the endoscope 6, based on the video signal that is outputted from the CCU 8.

The endoscope 6 as a medical image pickup apparatus includes an insertion portion 11 that is inserted into a body cavity, and an operation portion 12 that is provided on a distal end side of the insertion portion 11. A light guide 13 for transmitting the illuminating light supplied from the light source apparatus 7 is inserted through the inside of the endoscope 6 from a proximal end side of the insertion portion 11 to a distal end portion 14 on the distal end side of the insertion portion 11.

The distal end side of the light guide 13 is disposed in the distal end portion 14 of the endoscope 6, and a rear end side of the light guide 13 is configured to be connectable to the light source apparatus 7. According to this configuration, after illuminating light supplied from the light source apparatus 7 is transmitted by the light guide 13, the illuminating light is emitted from an illuminating window (unshown) that is provided in a distal end face of the distal end portion 14 of the insertion portion 11. The living tissue or the like as an object is illuminated by the illuminating light that is emitted from the aforementioned illuminating window.

An image pickup portion 17 is provided at the distal end portion 14 of the endoscope 6. The image pickup portion 17 includes an objective optical system 16 that is attached to an observation window (unshown) that is disposed at a position adjacent to the aforementioned illuminating window, an image pickup device 15 that is constituted by a CCD or the like and is disposed at an image formation position of the objective optical system 16.

The image pickup device 15 is connected to the CCU 8 through a signal wire. The image pickup device 15 is driven based on a drive signal that is outputted from the CCU 8, and outputs an image pickup signal obtained by picking up an image of the object that has been formed by the objective optical system 16 to the CCU 8.

The image pickup signal inputted to the CCU 8 is converted to a video signal by being subjected to signal processing in a signal processing circuit (unshown) provided inside the CCU 8, and the obtained video signal is outputted. The video signal outputted from the CCU 8 is inputted to the monitor 9 and the medical image processing apparatus 3. Thus, an image of the object that is based on the video signal outputted from the CCU 8 is displayed on the monitor 9.

The medical image processing apparatus 3 includes: an image input portion 21 that executes processing such as A/D conversion on the video signal that is outputted from the medical observation apparatus 2 and generates image data; a calculation processing portion 22 that includes a CPU or the like and that performs various kinds of processing with respect to image data or the like that is outputted from the image input portion 21; a program storage portion 23 that stores programs (and software) and the like relating to processing executed by the calculation processing portion 22; an image storage portion 24 capable of storing image data and the like that is outputted from the image input portion 21; and an information storage portion 25 capable of temporarily storing a processing result of the calculation processing portion 22.

The medical image processing apparatus 3 also includes: a storage apparatus interface 26 that is connected to a data bus 30 that is described later; a hard disk 27 that is capable of storing a processing result of the calculation processing portion 22 that is outputted through the storage apparatus interface 26; a display processing portion 28 that generates and outputs an image signal for displaying a processing result of the calculation processing portion 22 or the like as an image on the monitor 4; and an input operation portion 29 that includes an input apparatus such as a keyboard and that allows a user to input a parameter used in processing of the calculation processing portion 22 and an operating instruction and the like with respect to the medical image processing apparatus 3.

Note that the image input portion 21, the calculation processing portion 22, the program storage portion 23, the image storage portion 24, the information storage portion 25, the storage apparatus interface 26, the display processing portion 28 and the input operation portion 29 of the medical image processing apparatus 3 are connected to each other through the data bus 30.

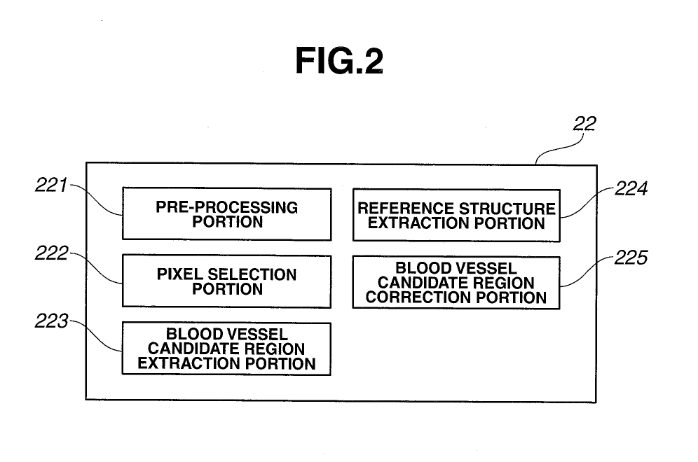

FIG. 2 is a diagram that shows an example of the configuration of a calculation processing portion that the medical image processing apparatus includes.

As shown in FIG. 2, the calculation processing portion 22 includes a pre-processing portion 221, a pixel selection portion 222, a blood vessel candidate region extraction portion 223, a reference structure extraction portion 224, and a blood vessel candidate region correction portion 225 that correspond to functions that are realized by executing a program or software or the like stored in the program storage portion 23. The functions of each portion of the calculation processing portion 22 are described later.

Next, operation of the medical system 1 that has the above described configuration will be described.

First, after the user applies power to each portion of the medical system 1, for example, the user inserts the insertion portion 11 into a subject until the distal end portion 14 reaches the inside of the stomach of the subject. In response thereto, an image of an object inside the stomach that is illuminated by illuminating light (RGB light) that is emitted from the distal end portion 14 is picked up by the image pickup portion 17, and an image pickup signal in accordance with the object for which an image is picked up is outputted to the CCU 8.

The CCU 8 executes signal processing with respect to the image pickup signal that is outputted from the image pickup device 15 of the image pickup portion 17 in the signal processing circuit (unshown) to thereby convert the image pickup signal into a video signal, and outputs the resulting video signal to the medical image processing apparatus 3 and the monitor 9. The monitor 9 displays an image of the object that has been picked up by the image pickup portion 17, based on the video signal outputted from the CCU 8.

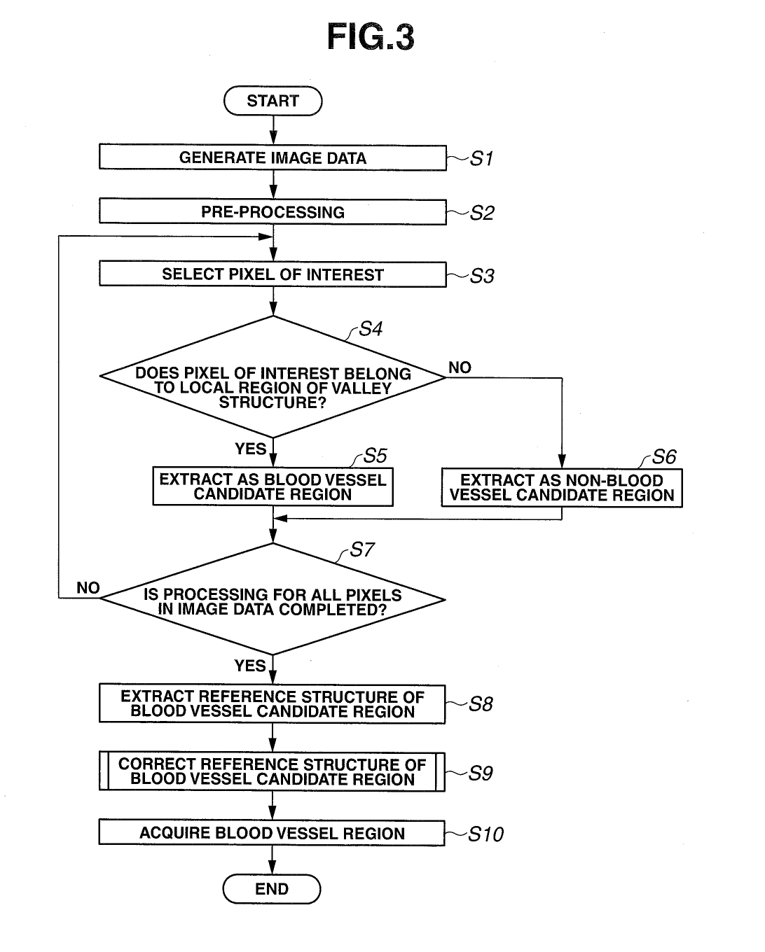

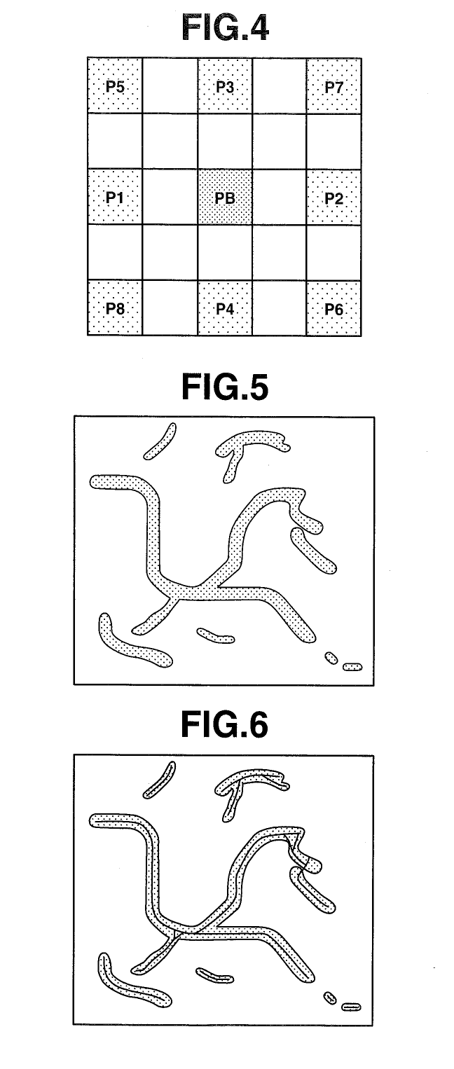

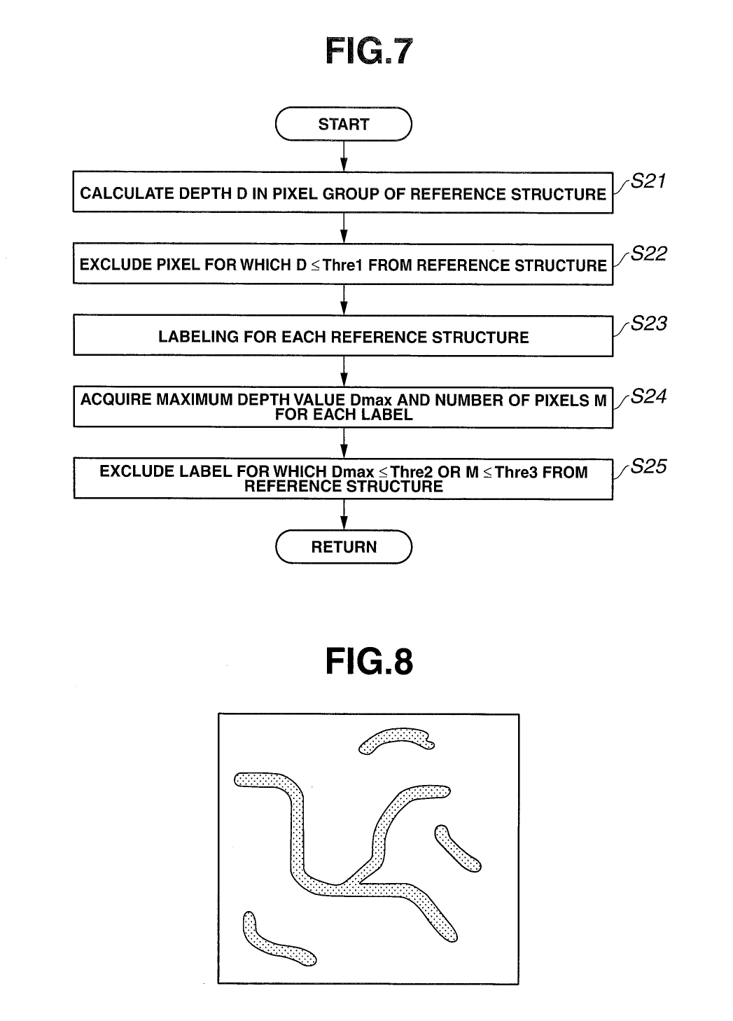

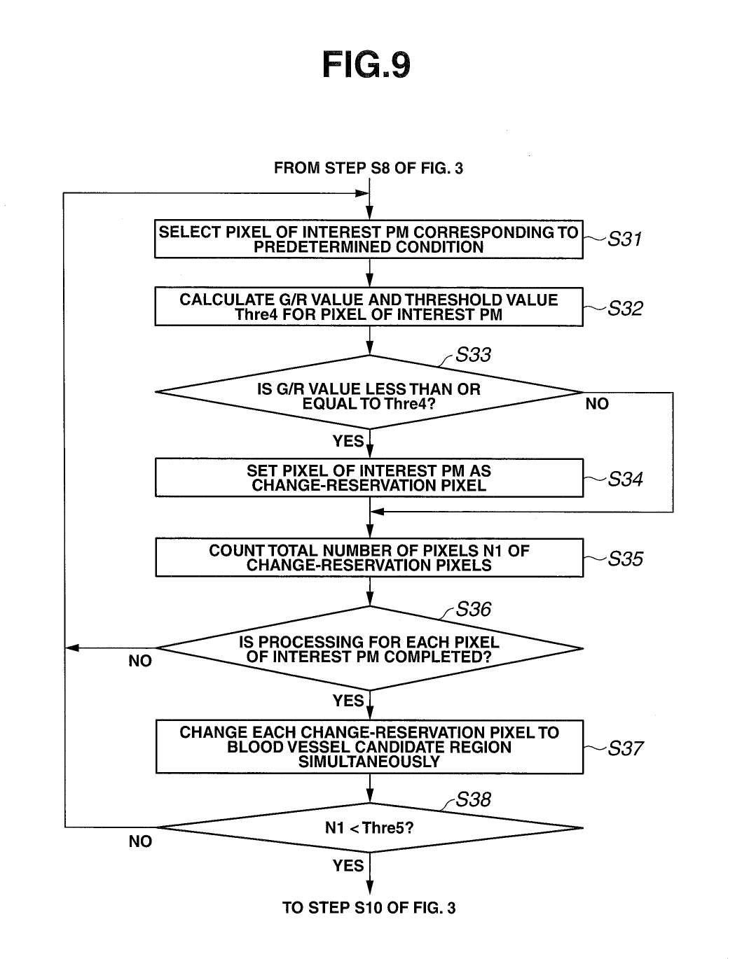

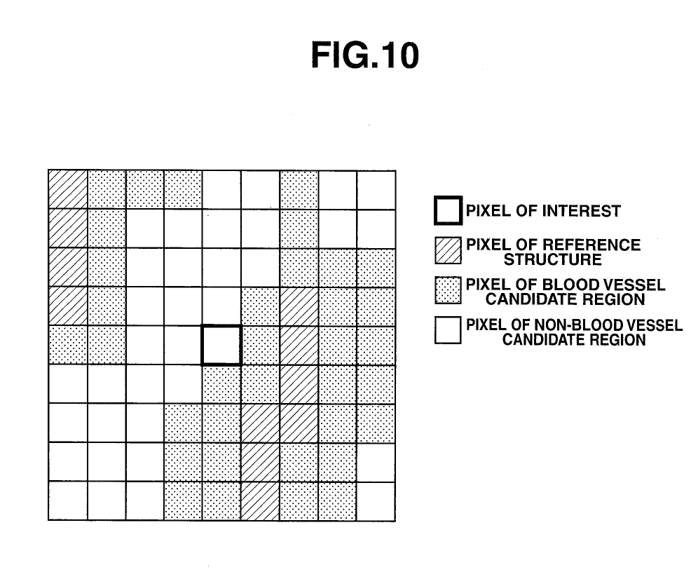

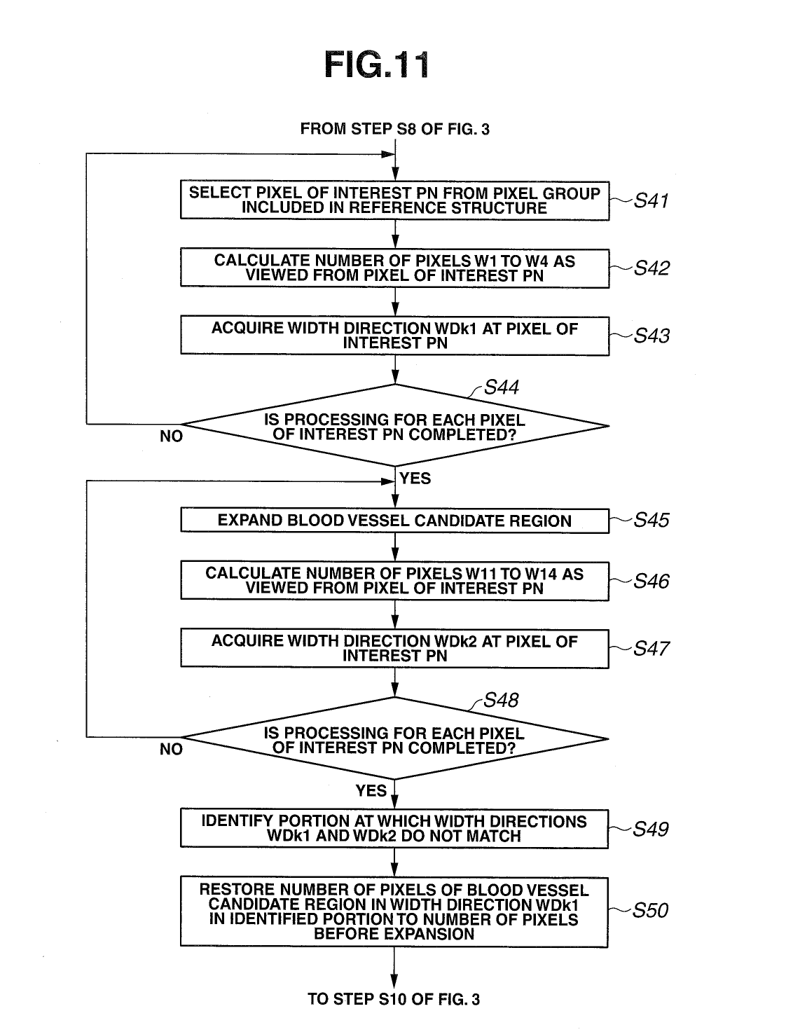

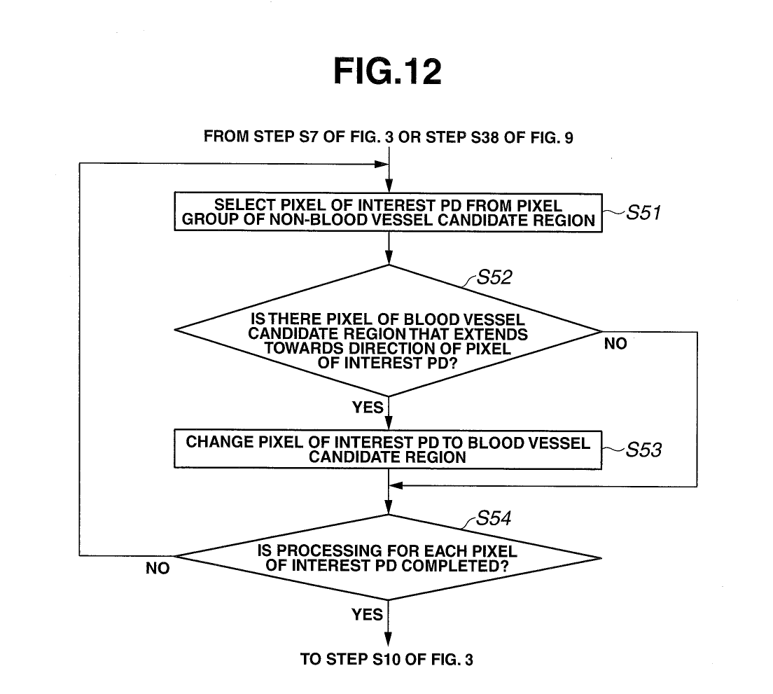

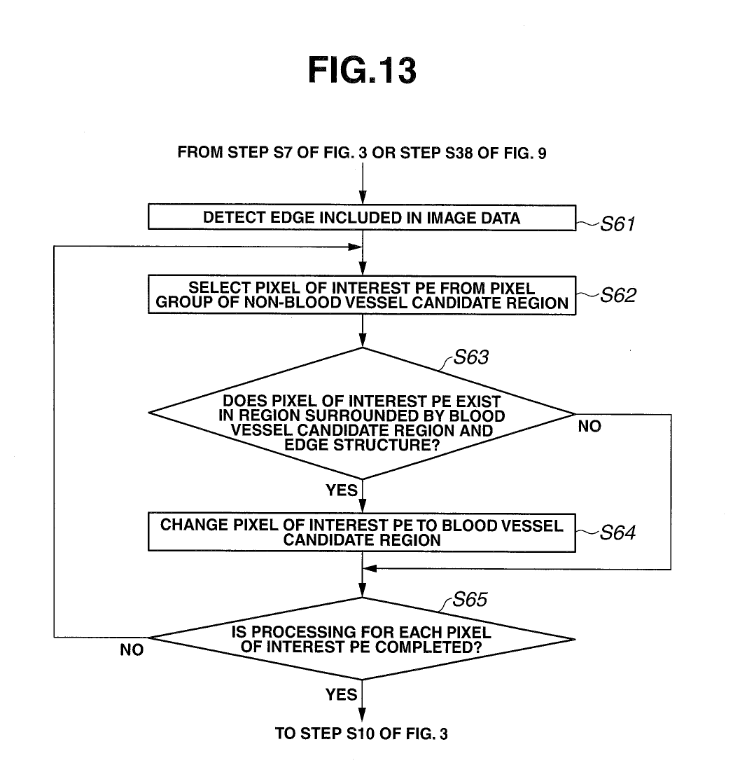

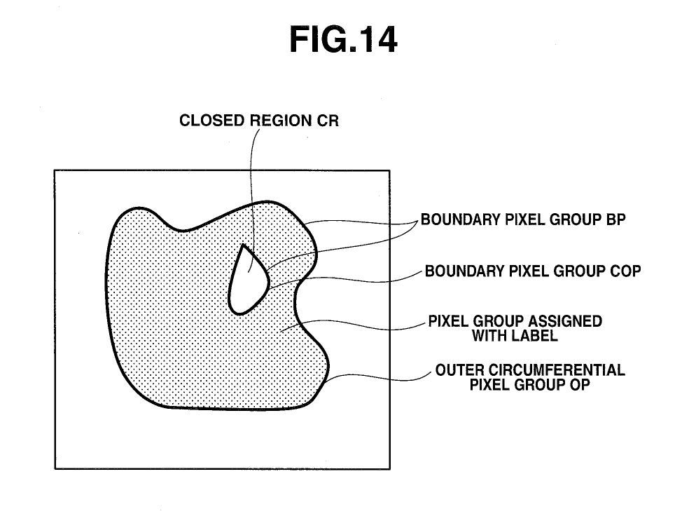

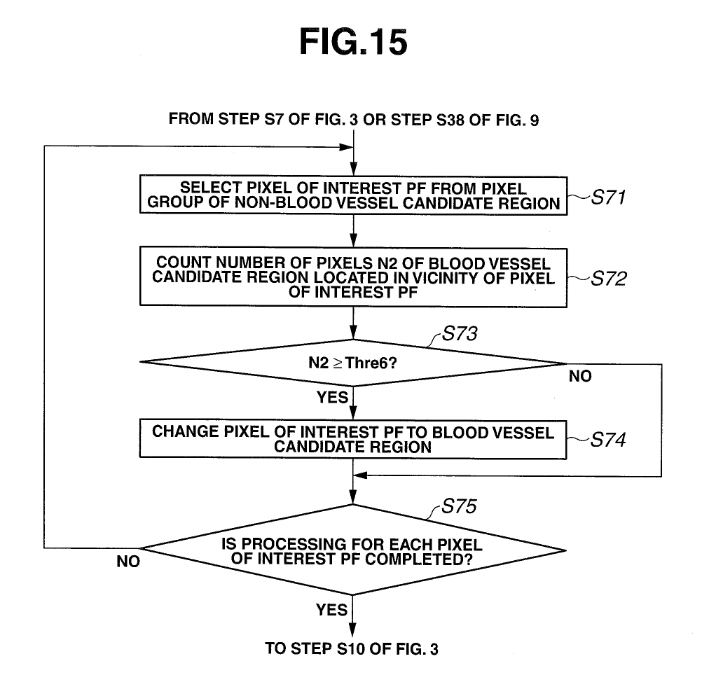

FIG. 3 is a flowchart that shows an example of processing performed by the medical image processing apparatus.

The image input portion 21 of the medical image processing apparatus 3 generates image data by subjecting an inputted video signal to processing such as A/D conversion, and outputs the generated image data to the calculation processing portion 22 (step S1 in FIG. 3). Note that it is assumed that image data generated by the image input portion 21 of the present embodiment has a size of, for example, length×width=ISX×ISY=640×480, and an R (red) component, G (green) component; and B (blue) component of each pixel has 8-bit gradations (256 gradations).

The pre-processing portion 221 of the calculation processing portion 22 executes pre-processing such as degamma processing and noise removal processing by means of a median filter with respect to the image data that is inputted from the image input portion 21 (step S2 in FIG. 3).

The pixel selection portion 222 of the calculation processing portion 22 selects a pixel of interest PB (i, j) at a pixel position (i, j) among the respective pixels in the image data (step S3 in FIG. 3). Note that, when the size (ISX×ISY=640×480) of the image data that is taken as an example in the foregoing is considered, 0≦i≦639 and 0≦j≦479. Further, the pixel selection portion 222 may, for example, select the pixel of interest PB while scanning the respective pixels of the image data one at a time in order from the left upper pixel to the right lower pixel, or may select the pixel of interest PB randomly from among the respective pixels in the image data.

The blood vessel candidate region extraction portion 223 of the calculation processing portion 22 includes a function as a feature value calculation portion, and calculates a value (hereinafter, referred to as G/R value) that is obtained by dividing a pixel value of a G component by a pixel value of an R component for each pixel in the image data, and acquires the calculation result as a feature value.

Note that, the blood vessel candidate region extraction portion 223 of the present embodiment may also acquire a value other than the G/R value as a feature value as long as the value is one that can lessen the influence produced by the object shape and the illumination state of illuminating light that illuminates the object. More specifically, the blood vessel candidate region extraction portion 223 may, for example, calculate a value obtained by dividing the pixel value of a G component by a sum of the pixel values of the respective components of R, G and B (value of (G/(R+G+B)) or a luminance value (value of L in a HLS color space) for each pixel in the image data, and acquire the calculation result as a feature value. Further, for example, the blood vessel candidate region extraction portion 223 may acquire an output value that is obtained by applying a band-pass filter or the like to a pixel value or a luminance value of respective pixels in the image data as a feature value.

The blood vessel candidate region extraction portion 223 that has a function as a judgment portion makes a judgment as to whether or not the pixel of interest PB belongs to a local region of a valley structure (concave structure) on the basis of comparison results obtained by comparing the feature value of the pixel of interest PB and feature values of eight peripheral pixels located in an extension direction of eight pixels in a vicinity of the pixel of interest PB, respectively (step S4 of FIG. 3).

FIG. 4 is a diagram for describing the positional relationship between the pixel of interest PB and peripheral pixels P1 to P8.

More specifically, based on comparison results obtained by comparing a feature value of the pixel of interest PB and the respective feature values of the peripheral pixels P1 to P8 that are in the positional relationship that is exemplified in FIG. 4, the blood vessel candidate region extraction portion 223 obtains a judgment result that the pixel of interest PB belongs to a local region of a valley structure in a case that corresponds to any of: a case where (the feature value of the pixel of interest PB)<(the feature value of the peripheral pixel P1) and (the feature value of the pixel of interest PB)<(the feature value of the peripheral pixel P2); a case where (the feature value of the pixel of interest PB)<(the feature value of the peripheral pixel P3) and (the feature value of the pixel of interest PB)<(the feature value of the peripheral pixel P4); a case where (the feature value of the pixel of interest PB)<(the feature value of the peripheral pixel P5) and (the feature value of the pixel of interest PB)<(the feature value of the peripheral pixel P6); and a case where (the feature value of the pixel of interest PB)<(the feature value of the peripheral pixel P7) and (the feature value of the pixel of interest PB)<(the feature value of the peripheral pixel P8).

Note that, according to the present embodiment, a peripheral pixel group that is used for the judgment processing in step S4 of FIG. 3 is not limited to a group in which eight peripheral pixels are set at regular intervals in a manner that skips single pixels inside a rectangular region of a size of 5×5 pixels as shown in the example in FIG. 4. More specifically, the number of peripheral pixels used in the aforementioned judgment processing in step S4 of FIG. 3 may be changed from the number used as an example in FIG. 4, a distance between each peripheral pixel and the pixel of interest PB that is used in the aforementioned judgment processing in step S4 of FIG. 3 may be changed from the distance shown as an example in FIG. 4, and the positional relationship between each peripheral pixel and the pixel of interest PB may be changed from the positional relationship shown as an example in FIG. 4.

Further, according to the present embodiment, a judgment that is made in step S4 of FIG. 3 is not limited to a judgment as to whether or not the pixel of interest PB belongs to a local region of a valley structure, and a judgment may also be made as to whether or not to make a judgment as to whether or not the pixel of interest PB belongs to a local region of a ridge structure (convex structure).

If the blood vessel candidate region extraction portion 223 obtains a judgment result to the effect that the pixel of interest PB belongs to a local region of a valley structure by the processing in step S4 of FIG. 3, the blood vessel candidate region extraction portion 223 extracts the relevant pixel of interest PB as a pixel of a blood vessel candidate region in which it is estimated that a blood vessel exists (step S5 in FIG. 3). Further, if the blood vessel candidate region extraction portion 223 obtains a judgment result to the effect that the pixel of interest PB does not belong to a local region of a valley structure by the processing in step S4 of FIG. 3, the blood vessel candidate region extraction portion 223 extracts the relevant pixel of interest PB as a pixel of a non-blood vessel candidate region in which it is estimated that a blood vessel does not exist (step S6 in FIG. 3).

FIG. 5 is a diagram that shows an example of a result of extracting blood vessel candidate regions.

The blood vessel candidate region extraction portion 223 repeatedly performs the processing shown from step S3 to step S6 of FIG. 3 until the processing is completed for all pixels in the image data (step S7 of FIG. 3). For example, an extraction result of blood vessel candidate regions as shown in FIG. 5 is obtained by the processing shown in step S3 to step S6 of FIG. 3 being repeatedly performed by the blood vessel candidate region extraction portion 223.

FIG. 6 is a diagram that shows an example of a result of extracting reference structures of blood vessel candidate regions.

The reference structure extraction portion 224 of the calculation processing portion 22 extracts a reference structure of a blood vessel candidate region that corresponds to a pixel group in a running direction of the blood vessel candidate region by executing known thinning processing with respect to a blood vessel candidate region that includes a pixel group extracted by the blood vessel candidate region extraction portion 223 (step S8 in FIG. 3). More specifically, for example, by executing thinning processing with respect to the blood vessel candidate region extraction result shown in FIG. 5, the reference structure extraction result shown in FIG. 6 is obtained.

Note that, a reference structure that is extracted in step S8 of FIG. 3 is not limited to a reference structure that is in accordance with a result of thinning processing and, for example, a center line of a blood vessel candidate region may be extracted as a reference structure. Further, in step S8 of FIG. 3, for example, a valley line (or a ridge line) that is detected based on a gradient direction of a blood vessel candidate region may also be extracted as a reference structure.

The blood vessel candidate region correction portion 225 of the calculation processing portion 22 executes processing to correct the reference structure of the blood vessel candidate region that is extracted by the processing in step S8 of FIG. 3 (step S9 in FIG. 3).

A specific example of the processing performed in step S9 of FIG. 3 will now be described. FIG. 7 is a flowchart that shows an example of processing relating to correction of a reference structure of a blood vessel candidate region.

The blood vessel candidate region correction portion 225 calculates a value of a depth D in a pixel group included in a reference structure extracted by the processing in step S8 of FIG. 3 (step S21 in FIG. 7).

More specifically, the blood vessel candidate region correction portion 225, for example, selects a pixel of interest PS from a pixel group included in a reference structure extracted by the processing in step S8 of FIG. 3, and calculates a value of the depth D by subtracting an average value of G/R values of each of eight pixels in the vicinity of the pixel of interest PS from the G/R value of the pixel of interest PS.

Note that, according to the present embodiment, a region that serves as an object for calculation of a value of the depth D is not limited to a rectangular region of a size of 3×3 pixels that includes the pixel of interest PS and eight pixels in the vicinity of the pixel of interest PS. For example, a region of another shape that is centered on the pixel of interest PS or a region of another size that is centered on the pixel of interest PS may be set as a region that serves as an object for calculation of the depth D value.

Further, the blood vessel candidate region correction portion 225 of the present embodiment is not limited to a portion that calculates a value of the depth D by subtracting an average value of the G/R values of each of eight pixels in the vicinity of the relevant pixel of interest PS from the G/R value of the pixel of interest PS and, for example, may be a portion that obtains the G/R value of the pixel of interest PS as it is as the value of the depth D.

Thereafter, the blood vessel candidate region correction portion 225 excludes pixels at which the depth D value is less than or equal to a threshold value Thre1 (for example, Thre1=0.01) from the reference structure extraction result obtained by the processing in step S8 of FIG. 3 (step S22 of FIG. 7). That is, according to the processing in step S22 of FIG. 7, a pixel at which the depth D as a value that indicates a fluctuation between the G/R value at the pixel of interest PS and the G/R values at each of eight pixels in the vicinity of the pixel of interest PS is less than or equal to the threshold value Thre1 is excluded from a pixel group included in the reference structure extracted by the processing in step S8 of FIG. 3. Further, in accordance with the processing in step S22 of FIG. 7, a blood vessel candidate region that is extracted so as to include a pixel group for which the value of the depth D is less than or equal to the threshold value Thre1 is changed to a non-blood vessel candidate region.

The blood vessel candidate region correction portion 225 executes known labeling processing with respect to each reference structure that remains after undergoing the processing in step S22 of FIG. 7 (step S23 in FIG. 7).

Based on the result of the labeling processing in step S23 of FIG. 7, the blood vessel candidate region correction portion 225 acquires a maximum depth value Dmax and a number of pixels M for each label (for each reference structure that has been assigned with a label) (step S24 of FIG. 7).

More specifically, the blood vessel candidate region correction portion 225, for example, acquires a maximum value of the depth D value as a maximum depth value Dmax for each label. Note that, the number of pixels M acquired by the blood vessel candidate region correction portion 225 in step S24 of FIG. 7 can be regarded as being equivalent to a length or an area for each label.

Based on the maximum depth value Dmax and the number of pixels M for each label acquired by the processing in step S24 of FIG. 7, the blood vessel candidate region correction portion 225 excludes from the reference structure a label that corresponds to either a label for which a value of the maximum depth value Dmax is less than or equal to a threshold value Thre2 (for example, Thre2=0.015) or a label for which the number of pixels M is less than or equal to a threshold value Thre3 (for example, Thre3=3.0) (step S25 of FIG. 7). In accordance with the processing in step S25 of FIG. 7, a blood vessel candidate region that has been extracted so as to include a pixel group in which a value of the maximum depth value Dmax is less than or equal to the threshold value Thre2 is changed to a non-blood vessel candidate region. Further, in accordance with the processing in step S25 of FIG. 7, a blood vessel candidate region that has been extracted so as to include a pixel group for which the number of pixels M is less than or equal to the threshold value Thre3 is changed to a non-blood vessel candidate region.

FIG. 8 is a diagram that shows an example of blood vessel candidate regions after correction.

That is, by the series of processing shown in FIG. 7 being performed in step S9 of FIG. 3, among the pixel groups included in a blood vessel candidate region at a time point at which the repeated processing from step S3 to step S7 of FIG. 3 is completed, pixels included in a region that is estimated to be different to a blood vessel are changed from a blood vessel candidate region to a non-blood vessel candidate region. Therefore, for example, in a case where a result of extracting blood vessel candidate regions as shown in FIG. 5 is obtained, the extraction result is corrected as shown in FIG. 8.

The calculation processing portion 22 detects (acquires) regions constituted by pixel groups that are blood vessel candidate regions at a time point at which the processing in step S9 of FIG. 3 is completed as blood vessel regions that are regions in which it can be regarded that blood vessels actually exist (step S10 of FIG. 3).

Note that, when performing the processing in step S9 of FIG. 3 (the series of processing shown in FIG. 7), the blood vessel candidate region correction portion 225 is not limited to use of a G/R value, and, for example, may use an output value that is obtained by applying a band-pass filter or the like to a pixel value or a luminance value of each pixel.

As processing for correcting a blood vessel candidate region at a time point at which the repeated processing from step S3 to step S7 in FIG. 3 is completed, instead of performing the processing shown in step S9 in FIG. 3, for example, the blood vessel candidate region correction portion 225 of the present embodiment may perform processing according to a first modification of the present embodiment that is described below. FIG. 9 is a flowchart that shows an example of processing for correcting a blood vessel candidate region.

The blood vessel candidate region correction portion 225 selects a pixel of interest PM that corresponds to a predetermined condition from the pixels included in the image data (step S31 of FIG. 9).

FIG. 10 is a diagram for explaining the positional relationship between the pixel of interest PM and other pixels.

More specifically, for example, the blood vessel candidate region correction portion 225 selects a pixel that has been extracted as a non-blood vessel candidate region and for which a blood vessel candidate region exists at any one of eight pixels in the vicinity thereof as the pixel of interest PM by scanning the pixels of the image data one at a time in order from the left upper pixel to the right lower pixel (see FIG. 10).

The blood vessel candidate region correction portion 225 calculates a feature value of the pixel of interest PM selected in step S31 of FIG. 9 as a G/R value and calculates a threshold value that is dynamically set in accordance with the processing result up to step S31 of FIG. 9 as a threshold value Thre4 (step S32 in FIG. 9), and thereafter judges whether or not the G/R value of the pixel of interest PM is equal to or less than the threshold value Thre4 (step S33 in FIG. 9).

Note that, the aforementioned threshold value Thre4 is calculated by the following equation (1) in a case where, for example, the G/R value of a pixel of a reference structure that is present at a position that is closest to the pixel of interest PM selected by step S31 of FIG. 9 is taken as “BaseGR” and an average value of the G/R values of a pixel group of a non-blood vessel candidate region that exists in a vicinal region that includes the pixel of interest PM selected by the processing in step S31 of FIG. 9 (for example, within a rectangular region of 9×9 that is centered on the pixel of interest PM) is taken as “AvgGR.”

Thre4={(AvgGR−BaseGR)×W1}+BaseGR (1)

Here, the value of W1 in the above equation (1) is set according to the class to which the value of the aforementioned BaseGR belongs in a case where the G/R values of a pixel group included in a reference structure extracted by the processing in step S8 of FIG. 3 are sorted in a sequential order and divided into a plurality of classes. More specifically, for example, in a case where the G/R values of a pixel group included in a reference structure extracted by step S8 of FIG. 3 are sorted in descending order and divided into five classes, the value of W1 in the above equation (1) is set to one of 0.4, 0.3, 0.15, 0.08, and 0.05 in accordance with the class to which the aforementioned BaseGR value belongs.

Note that the processing in step S32 of FIG. 9 is not limited to processing that calculates a feature value of the pixel of interest PM selected by step S31 of FIG. 9 as a G/R value, and may be processing that calculates another value other than a G/R value (for example, an output value of a band-pass filter). Further, the method of calculating the threshold value Thre4 in step S32 of FIG. 9 and a judgment condition of the threshold value Thre4 in step S33 of FIG. 9 may be appropriately changed in accordance with the range of possible values of the aforementioned other value and the like.

If the blood vessel candidate region correction portion 225 obtains a judgment result to the effect that the G/R value of the pixel of interest PM selected in step S31 of FIG. 9 is greater than the threshold value Thre4 upon performing the processing in step S33 of FIG. 9, the blood vessel candidate region correction portion 225 performs the processing in step S35 of FIG. 9 that is described later while maintaining the relevant pixel of interest PM as a non-blood vessel candidate region. Further, if the blood vessel candidate region correction portion 225 obtains a judgment result to the effect that the G/R value of the pixel of interest PM selected in step S31 of FIG. 9 is less than or equal to the threshold value Thre4 upon performing the processing in step S33 of FIG. 9, the blood vessel candidate region correction portion 225 sets the relevant pixel of interest PM as a change-reservation pixel with respect to which a change from a non-blood vessel candidate region to a blood vessel candidate region is reserved (step S34 in FIG. 9).

Thereafter, the blood vessel candidate region correction portion 225 counts a total number of pixels N1 of the change-reservation pixels at a time point at which the processing in step S33 or step S34 of FIG. 9 is completed and retains the obtained count value (step S35 in FIG. 9).

The blood vessel candidate region correction portion 225 repeatedly performs the processing shown in step S31 to step S35 of FIG. 9 until processing for each pixel of interest PM that corresponds to the predetermined condition in step S31 of FIG. 9 is completed (step S36 in FIG. 9).

Further, the blood vessel candidate region correction portion 225 simultaneously changes the respective change-reservation pixels that are set at the time point at which the repeated processing from step S31 to step S36 of FIG. 9 is completed from a non-blood vessel candidate region to a blood vessel candidate region (step S37 of FIG. 9).

In addition, the blood vessel candidate region correction portion 225 judges whether or not the count value of the total number of pixels N1 of the change-reservation pixels at a time point at which the repeated processing from step S31 to step S36 of FIG. 9 is completed is less than a threshold value Thre5 (for example, Thre5=1) (step S38 of FIG. 9).

If a judgment result to the effect that the count value of the total number of pixels N1 of the change-reservation pixels at a time point at which the repeated processing from step S31 to step S36 of FIG. 9 is completed is greater than or equal to the threshold value Thre5 is obtained upon performing the processing in step S38 of FIG. 9, the processing from step S31 of FIG. 9 is performed again using the processing result in step S37 of FIG. 9 that immediately precedes step S38 in which the relevant judgment result is obtained. In contrast, if a judgment result to the effect that the count value of the total number of pixels N1 of the change-reservation pixels at the time point at which the repeated processing from step S31 to step S36 of FIG. 9 is completed is less than the threshold value Thre5 is obtained upon performing the processing in step S38 of FIG. 9, the processing in step S10 of FIG. 3 is performed using the processing result in step S37 of FIG. 9 that immediately precedes step S38 in which the relevant judgment result is obtained.

That is, as described above as a first modification of the present embodiment, by performing the series of processing shown in FIG. 9, a blood vessel candidate region can be expanded so as to include a pixel with respect to which it is estimated a blood vessel actually exists.

Instead of performing the processing shown in step S9 of FIG. 3 as processing for correcting a blood vessel candidate region at a time point at which the repeated processing from step S3 to step S7 of FIG. 3 is completed, for example, the blood vessel candidate region correction portion 225 of the present embodiment may perform processing according to a second modification of the present embodiment that is described below. FIG. 11 is a flowchart that shows an example of processing for correcting a blood vessel candidate region that is different to the example shown in FIG. 9.

Based on the result of extracting a reference structure of a blood vessel candidate region in step S8 of FIG. 3, the blood vessel candidate region correction portion 225 selects a pixel of interest PN from a pixel group included in the relevant reference structure (step S41 in FIG. 11) and, furthermore, calculates a number of pixels W1 of a blood vessel candidate region in a horizontal direction (0° and 180° direction) D1, a number of pixels W2 of the blood vessel candidate region in a vertical direction (90° and 270° direction) D2, a number of pixels W3 of the blood vessel candidate region in a first diagonal direction (45° and 225° direction) D3, and a number of pixels W4 of the blood vessel candidate region in a second diagonal direction (135° and 315° direction) D4, respectively, as viewed from the relevant pixel of interest PN that has been selected (step S42 of FIG. 11).

The blood vessel candidate region correction portion 225 acquires the direction in which the number of pixels is smallest among the numbers of pixels W1 to W4 calculated in step S41 of FIG. 11 as a width direction WDk1 at the pixel of interest PN that is a width direction before correcting the blood vessel candidate region (step S43 of FIG. 11).

The blood vessel candidate region correction portion 225 repeatedly performs the processing from step S41 to step S43 of FIG. 11 until processing with respect to each pixel of interest PN in a pixel group included in the reference structure is completed (step S44 of FIG. 11).

After the processing up to step S44 of FIG. 11 is completed, as processing for expanding the blood vessel candidate region, for example, the blood vessel candidate region correction portion 225 performs the series of processing shown in step S31 to step S38 of FIG. 9 (step S45 of FIG. 11).

Further, the blood vessel candidate region correction portion 225 calculates numbers of pixels W11 to W14 that correspond to each of the aforementioned directions D1 to D4 as viewed from the pixel of interest PN by performing processing that is similar to the processing in step S42 of FIG. 11 using the processing result obtained in step S45 of FIG. 11 (step S46 of FIG. 11).

The blood vessel candidate region correction portion 225 acquires the direction in which the number of pixels is smallest among the numbers of pixels W11 to W14 calculated in step S46 of FIG. 11 as a width direction WDk2 at the pixel of interest PN that is a width direction after correcting the blood vessel candidate region (step S47 of FIG. 11).

The blood vessel candidate region correction portion 225 repeatedly performs the processing from step S45 to step S47 of FIG. 11 until processing with respect to each pixel of interest PN in a pixel group included in the reference structure is completed (step S48 of FIG. 11).

After the processing up to step S48 of FIG. 11 is completed, the blood vessel candidate region correction portion 225 identifies a portion at which the width direction WDk1 acquired by the processing in step S43 of FIG. 11 and a width direction WDk2 acquired by the processing in step S47 of FIG. 11 do not match (step S49 of FIG. 11).

The blood vessel candidate region correction portion 225 restores the number of pixels of the width direction WDk1 of the blood vessel candidate region at the portion identified by the processing in step S49 of FIG. 11 to the number of pixels prior to expansion thereof (prior to performing the processing in step S45 of FIG. 11) (step S50 of FIG. 11). In other words, by performing the processing in step S50 of FIG. 11, a change from a non-blood vessel candidate region to a blood vessel candidate region that has been made with respect to the portion at which the width directions WDk1 and WDk2 do not match is nullified.

Thereafter, the processing in step S10 of FIG. 3 is performed using the processing result obtained in step S50 of FIG. 11.

That is, by performing the series of processing shown in FIG. 11 as described above as a second modification of the present embodiment, a blood vessel candidate region can be expanded so as to include a pixel that is in accordance with the actual width of a blood vessel.

As described above, in the present embodiment, a pixel group belonging to a local region of a valley structure (concave structure) in image data is extracted as a blood vessel candidate region, the extracted blood vessel candidate region is corrected in accordance with a structural component of a blood vessel, and the corrected blood vessel candidate region is acquired as a blood vessel region (a region in which it can be regarded that a blood vessel actually exists). Therefore, according to the present embodiment, blood vessel regions can be acquired that include blood vessels of various thicknesses, blood vessels of various lengths, and blood vessels that accompany localized changes in a color tone of mucosa, respectively. As a result, blood vessels included in an image can be accurately detected.

Note that, the above described embodiment is not limited to detection of blood vessels and, for example, can be broadly applied to detection of tissue that has a linear structure, such as colonic pits or an epithelial structure. However, for example, in the case of applying the processing of the present embodiment to image data obtained by picking up an image of a colonic pit that has been subjected to gentian violet staining, it is necessary to appropriately change the judgment conditions and the like so as to conform to fluctuations in the pixel values.

Note that the above described embodiment is not limited to application to image data obtained by picking up an image with an endoscope and, for example, can also be used when detecting a line segment such as a blood vessel that is included in image data obtained by picking up an image of the ocular fundus.

### Second Embodiment

FIG. 12 relates to a second embodiment of the present invention.

In the present embodiment, the medical system 1 that has the same configuration as in the first embodiment can be used, and a part of the processing of the blood vessel candidate region correction portion 225 differs from the first embodiment. Therefore, in the present embodiment, of the processing of the blood vessel candidate region correction portion 225, a part of the processing that is different from the first embodiment is mainly described. Further, the processing of the blood vessel candidate region correction portion 225 of the present embodiment may be performed concurrently with the series of processing shown in FIG. 9 immediately after the processing in step S7 of FIG. 3 is completed, or may be performed in a consecutive manner immediately after the processing in step S38 of FIG. 9 is completed.

FIG. 12 is a flowchart that shows an example of processing for correcting a blood vessel candidate region that is different to the examples shown in FIG. 9 and FIG. 11.

Based on the processing result obtained in step S7 of FIG. 3 or in step S38 of FIG. 9, the blood vessel candidate region correction portion 225 selects a pixel of interest PD from a pixel group of a non-blood vessel candidate region included in the relevant processing result (step S51 of FIG. 12).

More specifically, the blood vessel candidate region correction portion 225, for example, selects the pixel of interest PD by scanning the pixels of the image data one at a time in order from the left upper pixel to the right lower pixel or selects the pixel of interest PD randomly from among the respective pixels in the image data.

The blood vessel candidate region correction portion 225 makes a judgment as to whether or not there is a pixel of a blood vessel candidate region that extends in the direction of the pixel of interest PD selected in step S51 of FIG. 12 among the pixel group of the blood vessel candidate region included in the processing result obtained in step S7 of FIG. 3 or in step S38 of FIG. 9 (step S52 of FIG. 12).

More specifically, when a group in which pixels of a blood vessel candidate region of three pixels or more in the image data are connected in the same linear direction is taken as a connecting pixel group and an extension direction of the connecting pixel group is taken as SD, the blood vessel candidate region correction portion 225, for example, makes a judgment in accordance with whether or not the pixel of interest PD is any of a predetermined number of pixels (for example, two pixels) that exist on the extension direction SD side when taking an end portion of the connecting pixel group as a starting point. If the pixel of interest PD is any of the predetermined number of pixels that exist on the extension direction SD side when taking the end portion of the connecting pixel group as a starting point, the blood vessel candidate region correction portion 225 obtains a judgment result to the effect that a pixel of a blood vessel candidate region that extends towards the direction of the pixel of interest PD exists. Further, if the pixel of interest PD is not any of the predetermined number of pixels that exist on the extension direction SD side when taking the end portion of the connecting pixel group as a starting point, the blood vessel candidate region correction portion 225 obtains a judgment result to the effect that a pixel of a blood vessel candidate region that extends towards the direction of the pixel of interest PD does not exist.

Note that, the number of pixels of the aforementioned connecting pixel group may be changed to an arbitrary number of pixels. Further, the extension direction SD that is determined in accordance with the aforementioned connecting pixel group is not limited to a linear direction, and may be a curved direction.

If the blood vessel candidate region correction portion 225 obtains a judgment result to the effect that a pixel of a blood vessel candidate region that extends towards the direction of the pixel of interest PD does not exist as the result of the processing in step S52 of FIG. 12, the blood vessel candidate region correction portion 225 performs the processing in step S54 of FIG. 12 that is described later while maintaining the relevant pixel of interest PD as a non-blood vessel candidate region. Further, if the blood vessel candidate region correction portion 225 obtains a judgment result to the effect that a pixel of a blood vessel candidate region that extends towards the direction of the pixel of interest PD does exist as the result of the processing in step S52 of FIG. 12, after changing the pixel of interest PD from a non-blood vessel candidate region to a blood vessel candidate region (step S53 of FIG. 12), the blood vessel candidate region correction portion 225 performs the processing in step S54 of FIG. 12 that is described later.

That is, if the blood vessel candidate region correction portion 225 detects that a predetermined pixel array pattern including a plurality of pixels of a blood vessel candidate region exists in the vicinity of the pixel of interest PD, the blood vessel candidate region correction portion 225 changes the pixel of interest PD from a non-blood vessel candidate region to a blood vessel candidate region.

Thereafter, the processing shown from step S51 to step S53 of FIG. 12 is repeatedly performed until the processing is completed for each pixel of interest PD (step S54 of FIG. 12). When the repeated processing from step S51 to step S54 of FIG. 12 is completed, the processing in step S10 of FIG. 3 is performed using the processing result at the time point at which the repeated processing is completed.

That is, by performing the series of processing shown in FIG. 12, a blood vessel candidate region can be expanded so that the occurrence of interruptions in a detection result (acquired result) for a blood vessel region is suppressed.

Therefore, according to the present embodiment, in addition to the advantageous effects described in the first embodiment, blood vessel regions in which there are few interruptions in the same blood vessel can be acquired. As a result, blood vessels included in an image can be accurately detected.

### Third Embodiment

FIG. 13 and FIG. 14 relate to a third embodiment of the present invention.

In the present embodiment, the medical system 1 that has the same configuration as in the first and second embodiments can be used, and a part of the processing of the blood vessel candidate region correction portion 225 differs from the first and second embodiments. Therefore, in the present embodiment, of the processing of the blood vessel candidate region correction portion 225, a part of the processing that is different from the first and second embodiments is mainly described. Further, the processing of the blood vessel candidate region correction portion 225 of the present embodiment may be performed concurrently with the series of processing shown in FIG. 9 immediately after the processing in step S7 of FIG. 3 is completed, or may be performed in a consecutive manner immediately after the processing in step S38 of FIG. 9 is completed.

FIG. 13 is a flowchart that shows an example of processing for correcting a blood vessel candidate region that is different to the examples shown in FIG. 9, FIG. 11 and FIG. 12.

After performing the processing in step S7 of FIG. 3 or in step S38 of FIG. 9, for example, the blood vessel candidate region correction portion 225 acquires an edge structure that is included in the image data by applying a filter such as a differential filter to the image data (step S61 of FIG. 13).

Based on the processing result obtained in step S7 of FIG. 3 or in step S38 of FIG. 9, the blood vessel candidate region correction portion 225 selects a pixel of interest PE from a pixel group of a non-blood vessel candidate region included in the relevant processing result (step S62 of FIG. 13).

More specifically, the blood vessel candidate region correction portion 225, for example, selects the pixel of interest PE by scanning the pixels of the image data one at a time in order from the left upper pixel to the right lower pixel or selects the pixel of interest PE randomly from among the respective pixels in the image data.

The blood vessel candidate region correction portion 225 makes a judgment as to whether or not the pixel of interest PE selected in step S62 of FIG. 13 is inside a region surrounded by the blood vessel candidate region and the edge structure (step S63 of FIG. 13).

FIG. 14 is an explanatory diagram for explaining a closed region CR.

More specifically, for example, after executing known labeling processing for each pixel in image data that corresponds to at least one of a blood vessel candidate region and an edge structure, the blood vessel candidate region correction portion 225 detects a pixel group located at a boundary between a pixel group to which a label is assigned and a pixel group to which a label is not assigned as a boundary pixel group BP, and also detects a pixel group located at an outermost portion of the pixel group to which a label is assigned as an outer circumferential pixel group OP. That is, it is considered that the relation “boundary pixel group BP⊃outer circumferential pixel group OP” is established between the boundary pixel group BP and the outer circumferential pixel group OP detected in this manner. Therefore, based on this relation, the blood vessel candidate region correction portion 225 detects as a boundary pixel group COP, a pixel group that is not detected as the outer circumferential pixel group OP and is detected as the boundary pixel group BP. Further, if the blood vessel candidate region correction portion 225 detects that the pixel of interest PE is included within a closed region CR (see FIG. 14) that is surrounded by the boundary pixel group COP, the blood vessel candidate region correction portion 225 obtains a judgment result to the effect that the relevant pixel of interest PE is within a region that is surrounded by the blood vessel candidate region and the edge structure. In addition, if the blood vessel candidate region correction portion 225 detects that the pixel of interest PE is not included within the closed region CR that is surrounded by the boundary pixel group COP, the blood vessel candidate region correction portion 225 obtains a judgment result to the effect that the relevant pixel of interest PE is outside a region that is surrounded by the blood vessel candidate region and the edge structure.

If the blood vessel candidate region correction portion 225 obtains the judgment result to the effect that the pixel of interest PE is outside a region that is surrounded by the blood vessel candidate region and the edge structure as a result of the processing in step S63 of FIG. 13, the blood vessel candidate region correction portion 225 performs the processing in step S65 of FIG. 13 that is described later while maintaining the relevant pixel of interest PE as a non-blood vessel candidate region. Further, if the blood vessel candidate region correction portion 225 obtains the judgment result to the effect that the pixel of interest PE is within a region that is surrounded by the blood vessel candidate region and the edge structure as a result of the processing in step S63 of FIG. 13, after changing the pixel of interest PE from a non-blood vessel candidate region to a blood vessel candidate region (step S64 of FIG. 13), the blood vessel candidate region correction portion 225 performs the processing in step S65 of FIG. 13 that is described later.

That is, when the blood vessel candidate region correction portion 225 detects that the pixel of interest PE is inside a region that is surrounded by the blood vessel candidate region and the edge structure, the blood vessel candidate region correction portion 225 changes the pixel of interest PE from a non-blood vessel candidate region to a blood vessel candidate region.

Thereafter, the processing shown from step S62 to step S64 of FIG. 13 is repeatedly performed until the processing is completed for each pixel of interest PE (step S65 of FIG. 13). When the repeated processing from step S62 to step S65 of FIG. 13 is completed, the processing in step S10 of FIG. 3 is performed using the processing result at the time point at which the repeated processing is completed.

That is, by performing the series of processing shown in FIG. 13, a blood vessel candidate region can be expanded so that the occurrence of interruptions in a detection result (acquired result) for a blood vessel region is suppressed.

Therefore, according to the present embodiment, in addition to the advantageous effects described in the first embodiment, blood vessel regions in which there are few interruptions in the same blood vessel can be acquired. As a result, blood vessels included in an image can be accurately detected.

### Fourth Embodiment

FIG. 15 relates to a fourth embodiment of the present invention.

In the present embodiment, the medical system 1 that has the same configuration as in the first to third embodiments can be used, and a part of the processing of the blood vessel candidate region correction portion 225 differs from the first to third embodiments. Therefore, in the present embodiment, of the processing of the blood vessel candidate region correction portion 225, a part of the processing that is different from the first to third embodiments is mainly described. Further, the processing of the blood vessel candidate region correction portion 225 of the present embodiment may be performed concurrently with the series of processing shown in FIG. 9 immediately after the processing in step S7 of FIG. 3 is completed, or may be performed in a consecutive manner immediately after the processing in step S38 of FIG. 9 is completed.

FIG. 15 is a flowchart that shows an example of processing for correcting a blood vessel candidate region that is different to the examples shown in FIG. 9, FIG. 11, FIG. 12 and FIG. 13.

Based on the processing result obtained in step S7 of FIG. 3 or in step S38 of FIG. 9, the blood vessel candidate region correction portion 225 selects a pixel of interest PF from a pixel group of a non-blood vessel candidate region included in the relevant processing result (step S71 of FIG. 15).

More specifically, the blood vessel candidate region correction portion 225, for example, selects the pixel of interest PF by scanning the pixels of the image data one at a time in order from the left upper pixel to the right lower pixel or selects the pixel of interest PF randomly from among the respective pixels in the image data.

The blood vessel candidate region correction portion 225 counts the number of pixels N2 of a blood vessel candidate region located in the vicinity of the pixel of interest PF (for example, eight vicinal pixels) (step S72 of FIG. 15). Note that a region that is an object for counting of the number of pixels N2 of the blood vessel candidate region may be a region that has an arbitrary size and shape as long as the region is one that is centered on the pixel of interest PF.

The blood vessel candidate region correction portion 225 judges whether or not the count value of the number of pixels N2 is greater than or equal to a threshold value Thre6 (for example, Thre6=5) (step S73 in FIG. 15).

If a judgment result to the effect that the count value of the number of pixels N2 is less than the threshold value Thre6 is obtained by the processing in step S73 of FIG. 15, the blood vessel candidate region correction portion 225 performs the processing in step S75 of FIG. 15 that is described later while maintaining the relevant pixel of interest PF as a non-blood vessel candidate region. In contrast, if a judgment result to the effect that the count value of the number of pixels N2 is greater than or equal to the threshold value Thre6 is obtained by the processing in step S73 of FIG. 15, the blood vessel candidate region correction portion 225 changes the pixel of interest PF from a non-blood vessel candidate region to a blood vessel candidate region (step S74 in FIG. 15), and thereafter performs the processing in step S75 of FIG. 15 that is described later.

That is, when the blood vessel candidate region correction portion 225 detects that the number of pixels N2 of the blood vessel candidate region located in the vicinity of the pixel of interest PF is greater than or equal to the threshold value Thre6, the blood vessel candidate region correction portion 225 changes the pixel of interest PF from a non-blood vessel candidate region to a blood vessel candidate region.

Thereafter, the processing shown from step S71 to step S74 of FIG. 15 is repeatedly performed until the processing is completed for each pixel of interest PF (step S75 of FIG. 15). When the repeated processing from step S71 to step S75 of FIG. 15 is completed, the processing in step S10 of FIG. 3 is performed using the processing result at the time point at which the repeated processing is completed.

That is, by performing the series of processing shown in FIG. 15, a blood vessel candidate region can be expanded so that the occurrence of interruptions in a detection result (acquired result) for a blood vessel region is suppressed.

Therefore, according to the present embodiment, in addition to the advantageous effects described in the first embodiment, blood vessel regions in which there are few interruptions in the same blood vessel can be acquired. As a result, blood vessels included in an image can be accurately detected.

Note that the present invention is not limited to the respective embodiments that are described above, and naturally various changes and adaptations are possible within a range that does not depart from the spirit and scope of the present invention.

What is claimed is:

1. A medical image processing apparatus, comprising:
a feature value calculation portion that, for each pixel of an image that is obtained by picking up an image of living tissue, calculates a feature value that is used when extracting a linear structure from the image;
a judgment portion that, based on a result of a comparison between the feature value that is calculated for a first pixel of interest in the image and the feature values that are calculated for a plurality of pixels located in a vicinity of the first pixel of interest, judges whether the first pixel of interest is a linear structure pixel that corresponds to a linear structure or is a nonlinear structure candidate pixel; and
a correction portion that, by extraction, identifies a pixel that is determined to be a linear structure pixel that is in a vicinity of the nonlinear structure candidate pixel, calculates information with respect to the identified linear structure candidate pixels that is necessary for identifying whether to make the nonlinear structure candidate pixel the linear structure pixel or a nonlinear structure pixel, and determines whether to make the nonlinear structure candidate pixel the nonlinear structure pixel or the linear structure pixel based on the information that is calculated.

2. The medical image processing apparatus according to claim 1, wherein the correction portion further selects a second pixel of interest from among the nonlinear structure candidate pixels, further calculates information with respect to the second pixel of interest that is necessary for identifying whether to make the second pixel of interest a nonlinear structure pixel or a linear structure pixel, and determines whether to make the second pixel of interest the nonlinear structure pixel or the linear structure pixel in accordance with a result of a comparison between a threshold value that is dynamically set based on the information that is calculated with respect to the identified linear structure candidate pixels and the information that is calculated with respect to the second pixel of interest.

3. The medical image processing apparatus according to claim 1, wherein the correction portion further selects a second pixel of interest from among the nonlinear structure candidate pixels, calculates existence or non-existence of a predetermined array pattern comprising a plurality of pixels in the identified linear structure candidate pixels as the information with respect to the identified linear structure candidate pixels, and determines the second pixel of interest to be the linear structure pixel in a case where the predetermined array pattern exists among the identified linear structure candidate pixels.

4. The medical image processing apparatus according to claim 1, wherein the correction portion acquires an edge structure in the image, selects a second pixel of interest from among the nonlinear structure candidate pixels, further calculates whether or not the second pixel of interest is a region that is surrounded by the linear structure pixels and the edge structure as the information with respect to the identified linear structure candidate pixels, and determines the second pixel of interest to be the linear structure pixel in a case where the second pixel of interest is a region that is surrounded by the linear structure pixels and the edge structure.

5. The medical image processing apparatus according to claim 1, wherein the correction portion selects a second pixel of interest from among the nonlinear structure candidate pixels, calculates the number of pixels of the linear structure pixels that are located in a vicinity of the second pixel of interest as the information with respect to the identified linear structure candidate pixels, and determines the second pixel of interest to be the linear structure pixel in a case where the number of pixels of the linear structure pixels that are located in a vicinity of the second pixel of interest is greater than or equal to a predetermined number.

6. The medical image processing apparatus according to claim 1, wherein the correction portion acquires width direction information of the linear structure pixels based on the linear structure pixels before and after determining whether to make the nonlinear structure candidate pixels the nonlinear structure pixel or the linear structure pixel, respectively, and nullifies a determination to make the nonlinear structure candidate pixels the nonlinear structure pixel or the linear structure pixel that is made with respect to a portion at which the two pieces of width direction information that are acquired do not match.

7. A method of operating a medical image processing apparatus, comprising:
a feature value calculation step of, for each pixel of an image that is obtained by picking up an image of living tissue, calculating a feature value that is used when extracting a linear structure from the image;
a judgment step of, based on a result of a comparison between the feature value that is calculated for a first pixel of interest in the image and the feature values that are calculated for a plurality of pixels located in a vicinity of the first pixel of interest, judging whether the first pixel of interest is a linear structure pixel that corresponds to a linear structure or is a nonlinear structure candidate pixel; and
a correction step of, by extraction, identifying a pixel that is determined to be a linear structure pixel that is in a vicinity of the nonlinear structure candidate pixel, calculating information with respect to the identified linear structure candidate pixels that is necessary for identifying whether to make the nonlinear structure candidate pixel the linear structure pixel or a nonlinear structure pixel, and determining whether to make the nonlinear structure candidate pixel the nonlinear structure pixel or the linear structure pixel based on the information that is calculated.

8. The method of operating a medical image processing apparatus according to claim 7, wherein the correction step further comprises:
selecting a second pixel of interest from among the nonlinear structure candidate pixels, and calculating information with respect to the second pixel of interest that is necessary for identifying whether to make the second pixel of interest a nonlinear structure pixel or a linear structure pixel; and
determining whether to make the second pixel of interest the nonlinear structure pixel or the linear structure pixel in accordance with a result of a comparison between a threshold value that is dynamically set based on the information that is calculated with respect to the identified linear structure candidate pixels and the information that is calculated with respect to the second pixel of interest.

9. The method of operating a medical image processing apparatus according to claim 7, wherein the correction step further comprises:
selecting a second pixel of interest from among the nonlinear structure candidate pixels; and
calculating existence or non-existence of a predetermined array pattern comprising a plurality of pixels in the identified linear structure candidate pixels as the information with respect to the identified linear structure candidate pixels, and determining the second pixel of interest to be the linear structure pixel in a case where the predetermined array pattern exists among the identified linear structure candidate pixels.

10. The method of operating a medical image processing apparatus according to claim 7, wherein the correction step comprises:
acquiring an edge structure in the image, selecting a second pixel of interest from among the nonlinear structure candidate pixels, calculating whether or not the second pixel of interest is a region that is surrounded by the linear structure pixels and the edge structure as the information with respect to the identified linear structure candidate pixels, and determining the second pixel of interest to be the linear structure pixel in a case where the second pixel of interest is a region that is surrounded by the linear structure pixels and the edge structure.

11. The method of operating a medical image processing apparatus according to claim 7, wherein the correction step comprises:
selecting a second pixel of interest from among the nonlinear structure candidate pixels, calculating the number of pixels of the linear structure pixels that are located in a vicinity of the second pixel of interest as the information with respect to the identified linear structure candidate pixels, and determining the second pixel of interest to be the linear structure pixel in a case where the number of pixels of the linear structure pixels that are located in a vicinity of the second pixel of interest is greater than or equal to a predetermined number.

12. The method of operating a medical image processing apparatus according to claim 7, wherein the correction step comprises:
acquiring width direction information of the linear structure pixels based on the linear structure pixels before and after determining whether to make the nonlinear structure candidate pixels the nonlinear structure pixel or the linear structure pixel, respectively, and nullifying a determination to make the nonlinear structure candidate pixels the nonlinear structure pixel or the linear structure pixel that is made with respect to a portion at which the two pieces of width direction information that are acquired do not match.
